(19) United States
(12) Patent Application Publication
(10) Pub. No.: US 2022/0363586 A1
(43) Pub. Date: Nov. 17, 2022

(54) GLASS COMPOSITIONS WITH HIGH MODULUS AND LARGE CTE RANGE FOR LAMINATE STRUCTURES

(71) Applicant: CORNING INCORPORATED, CORNING, NY (US)

(72) Inventors: Timothy Michael Gross, Painted Post, NY (US); Jingshi Wu, Painted Post, NY (US)

(21) Appl. No.: 17/771,162

(22) PCT Filed: Oct. 12, 2020
(86) PCT No.: PCT/US2020/055185

§ 371 Date: Apr. 22, 2022

Related U.S. Application Data
(60) Provisional application No. 62/927,543, filed on Oct. 29, 2019.

(51) Int. Cl. C03C 3/091; C03C 17/02

(52) U.S. Cl. CPC C03C 3/091; C03C 17/02; C03C 2218/13; C03C 2218/365

(57) ABSTRACT

A glass composition includes from about 50 mol. % to about 70 mol. % SiO₂, from about 0.1 mol. % to about 10 mol. % Al₂O₃, from about 5 mol. % to about 25 mol. % B₂O₃, and from about 10 mol. % to about 30 mol. % of a modifier, wherein the modifier is at least one of Na₂O, K₂O and CaO.

### CROSS-REFERENCE TO RELATED APPLICATIONS

This application claims the benefit of priority under 35 U.S.C § 119 of U.S. Provisional Application Ser. No. 62/927,543 filed on Oct. 29, 2019, the content of which is relied upon and incorporated herein by reference in its entirety.

### TECHNICAL FIELD

This disclosure relates to laminate glass structures for use in microelectronic carrier applications. More particularly, the disclosure relates to a glass laminates having a high Young's modulus and a tunable CTE.

### BACKGROUND

Glass articles are used in a variety of products and industries, including consumer and commercial devices. Various processes may be used to strengthen glass articles, including chemical tempering, thermal tempering, ion-exchange and lamination. Lamination mechanical glass strengthening enables the glass device to withstand repeated damage from handling and use. Such glass devices are generally made by thermally bonding or laminating a glass core or center layer and one or two outer cladding or skin layers. The contrast between the thermal and mechanical properties of the core and the cladding layers can influence the compressive strength and fracture formation or propagation in the cladding layer glass laminate.

Accordingly, a need exists for alternative glass materials for use in laminated glass structures and methods for making the same.

### SUMMARY

According to a first aspect, a glass composition comprises from about 50 mol. % to about 70 mol. % SiO₂, from about 0.1 mol. % to about 10 mol. % Al₂O₃, from about 5 mol. % to about 25 mol. % B₂O₃ and from about 10 mol. % to about 30 mol. % of a modifier, wherein the modifier is at least one of Na₂O, K₂O and CaO. In certain embodiments, the ratio of mol. % of Al₂O₃ and B₂O₃ to modifier is from about 0.95 to about 1.05.

In certain embodiments, the glass composition has a Young's modulus of at least 79 GPa. In certain embodiments, the glass composition has a Young's modulus that is less than 100 GPa. In certain embodiments, the glass composition has a coefficient of thermal expansion from 8.0 ppm/° C. to 10.0 ppm/° C. In certain embodiments, the modifier comprises Na₂O and CaO. In certain embodiments, the modifier comprises Na₂O, K₂O and CaO. In certain embodiments, the modifier converts boron in B₂O₃ from trigonal to tetrahedral configuration. In certain embodiments, the glass composition further comprises from about 0 mol. % to about 3 mol. % of one or more of Y₂O₃, La₂O₃, ZrO₂, TiO₂, BeO or Ta₂O₅.

According to a second aspect, a glass article comprises a glass core layer disposed between a first glass cladding layer and a second glass cladding layer. The glass core layer comprises a glass composition from about 50 mol. % to about 70 mol. % SiO₂, from about 0.1 mol. % to about 10 mol. % Al₂O₃, from about 5 mol. % to about 25 mol. % B₂O₃ and from about 10 mol. % to about 30 mol. % of a modifier, wherein the modifier is at least one of Na₂O, K₂O and CaO. In certain embodiments of the glass article of second aspect, the ratio of mol. % of Al₂O₃ and B₂O₃ to modifier is from about 0.95 to about 1.05.

In certain embodiments of the glass article of second aspect, the glass composition has a Young's modulus of at least 79 GPa. In certain embodiments of the glass article of second aspect, the glass composition has a Young's modulus that is less than 100 GPa. In certain embodiments of the glass article of second aspect, the glass composition has a coefficient of thermal expansion from 8.0 ppm/° C. to 10.0 ppm/° C. In certain embodiments of the glass article of second aspect, the modifier comprises Na₂O and CaO. In certain embodiments of the glass article of second aspect, the modifier comprises Na₂O, K₂O and CaO. In certain embodiments of the glass article of second aspect, the modifier converts boron in B₂O₃ from trigonal to tetrahedral configuration. In certain embodiments of the glass article of second aspect, the glass composition further comprises from about 0 mol. % to about 3 mol. % of one or more of Y₂O₃, La₂O₃, ZrO₂, TiO₂, BeO or Ta₂O₅.

According to a third aspect, a glass article comprises a glass core layer disposed between a first glass cladding layer and a second glass cladding layer. The glass core layer comprises a glass composition having a Young's modulus (Y_{core}) of at least 79 GPa, and a coefficient of thermal expansion (CTE_{core}) between 8.0 ppm/° C. and 10.0 ppm/° C. The first glass cladding layer and a second glass cladding layer comprise a glass composition having a Young's modulus of (Y_{clad}) at least 79 GPa, and a coefficient of thermal expansion (CTE_{clad}) between 3.5 ppm/° C. and 5.5 ppm/° C.

In certain embodiments of the glass article of third aspect, the glass article has a coefficient of thermal expansion (CTE_{article}) between 3.5 ppm/° C. to 10.0 ppm/° C. In certain embodiments of the glass article of third aspect, the glass article has a coefficient of thermal expansion (CTE_{article}) between 4 ppm/° C. and 9.5 ppm/° C. In certain embodiments of the glass article of third aspect, the glass article has a Young's Modulus (V article) between 80 Gpa and 100 Gpa.

In certain embodiments of the glass article of third aspect, the glass composition of the glass core layer comprises from about 50 mol. % to about 70 mol. % SiO₂, from about 0.1 mol. % to about 10 mol. % Al₂O₃, from about 5 mol. % to about 25 mol. % B₂O₃, and from about 10 mol. % to about 30 mol. % of a modifier, wherein the modifier is at least one of Na₂O, K₂O and CaO. In certain embodiments of the glass article of third aspect, the glass composition of the first glass cladding layer and the second glass cladding layer comprises from about 40 mol. % to about 65 mol. % SiO₂, from about 0.1 mol. % to about 20 mol. % Al₂O₃, from about 5 mol. % to about 25 mol. % B₂O₃, and from about 5 mol. % to about 40 mol. % of a modifier, wherein the modifier is at least one of MgO and CaO.

In certain embodiments of the glass article of third aspect, the glass core layer has an average core coefficient of thermal expansion (CTE_{coreAvg}) and the first glass cladding layer and the second glass cladding layer have an average cladding coefficient of thermal expansion (CTE_{cladAvg}) that is less than the average core coefficient of thermal expansion (CTE_{coreAvg}).

According to a fourth aspect, a method for forming a glass composition comprises melting a batch and forming a precursor glass comprising from about 50 mol. % to about 70 mol. % SiO₂, from about 0.1 mol. % to about 10 mol. % Al₂O₃, from about 5 mol. % to about 25 mol. % B₂O₃, and from about 10 mol. % to about 30 mol. % of a modifier, wherein the modifier is at least one of Na₂O, K₂O and CaO.

According to a fifth aspect, a method for forming a laminated glass article comprises contacting a molten core glass composition with a molten cladding glass composition to form a laminated glass article comprising a glass core layer disposed between a first glass cladding layer and a second glass cladding layer. The glass core layer comprises a glass composition having a Young's modulus (Y_{core}) of at least 79 GPa, and a coefficient of thermal expansion (CTE_{core}) between 8.0 ppm/° C. and 10.0 ppm/° C. The first glass cladding layer and a second glass cladding layer comprise a glass composition having a Young's modulus (Y_{clad}) of at least 79 GPa, and a coefficient of thermal expansion (CTE_{clad}) between 3.5 ppm/° C. and 5.5 ppm/° C.

According to a sixth aspect, a device comprises from about 50 mol. % to about 70 mol. % SiO₂, from about 0.1 mol. % to about 10 mol. % Al₂O₃, from about 5 mol. % to about 25 mol. % B₂O₃ and from about 10 mol. % to about 30 mol. % of a modifier, wherein the modifier is at least one of Na₂O, K₂O and CaO. In certain embodiments of the device of sixth aspect, the ratio of mol. % of Al₂O₃ and B₂O₃ to modifier is from about 0.95 to about 1.05.

In certain embodiments of the device of sixth aspect, the glass composition has a Young's modulus of at least 79 GPa. In certain embodiments of the device of sixth aspect, the glass composition has a Young's modulus that is less than 100 GPa. In certain embodiments of the device of sixth aspect, the glass composition has a coefficient of thermal expansion from 8.0 ppm/° C. to 10.0 ppm/° C. In certain embodiments of the device of sixth aspect, the modifier comprises Na₂O and CaO. In certain embodiments of the device of sixth aspect, the modifier comprises Na₂O, K₂O and CaO. In certain embodiments of the device of sixth aspect, the modifier converts boron in B₂O₃ from trigonal to tetrahedral configuration. In certain embodiments of the device of sixth aspect, the glass composition further comprises from about 0 mol. % to about 3 mol. % of one or more of Y₂O₃, La₂O₃, ZrO₂, TiO₂, BeO or Ta₂O₅. In certain embodiments of the device of sixth aspect, the device is an electronic device, an automotive device, an architectural device or an appliance device.

According to a seventh aspect, a device comprises a glass core layer disposed between a first glass cladding layer and a second glass cladding layer. The glass core layer comprises a glass composition having a Young's modulus (Y_{core}) of at least 79 GPa, and a coefficient of thermal expansion (CTE_{core}) between 8.0 ppm/° C. and 10.0 ppm/° C. The first glass cladding layer and a second glass cladding layer comprise a glass composition having a Young's modulus (Y_{clad}) of at least 79 GPa, and a coefficient of thermal expansion (CTE_{clad}) between 3.5 ppm/° C. and 5.5 ppm/° C.

In certain embodiments of the device of seventh aspect, the device has a coefficient of thermal expansion between 3.5 ppm/° C. and 10.0 ppm/° C. In certain embodiments of the device of seventh aspect, the device has a coefficient of thermal expansion between 4 ppm/° C. and 9.5 ppm/° C. In certain embodiments of the device of seventh aspect, the device has a Young's Modulus between 80 Gpa and 100 Gpa.

In certain embodiments of the device of seventh aspect, the glass composition of the glass core layer comprises from about 50 mol. % to about 70 mol. % SiO₂, from about 0.1 mol. % to about 10 mol. % Al₂O₃, from about 5 mol. % to about 25 mol. % B₂O₃, and from about 10 mol. % to about 30 mol. % of a modifier, wherein the modifier is at least one of Na₂O, K₂O and CaO. In certain embodiments of the device of seventh aspect, the glass composition of the first glass cladding layer and the second glass cladding layer comprises from about 40 mol. % to about 65 mol. % SiO₂, from about 0.1 mol. % to about 20 mol. % Al₂O₃, from about 5 mol. % to about 25 mol. % B₂O₃, and from about 5 mol. % to about 40 mol. % of a modifier, wherein the modifier is at least one of MgO and CaO.

In certain embodiments of the device of seventh aspect, the glass core layer has an average core coefficient of thermal expansion (CTE_{coreAvg}) and the first glass cladding layer and the second glass cladding layer have an average cladding coefficient of thermal expansion (CTE_{cladAvg}) that is less than the average core coefficient of thermal expansion (CTE_{coreAvg}). In certain embodiments of the device of seventh aspect, the device is an electronic device, an automotive device, an architectural device or an appliance device.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is a cross-sectional schematic view of a glass article in accordance with one or more embodiments shown and described herein.

Like reference numbers and designations in the various drawings indicate like elements.

### DETAILED DESCRIPTION

Reference will now be made in detail to various embodiments which are illustrated in the accompanying drawings. Whenever possible, the same reference numerals will be used throughout the drawings to refer to the same or like parts. The components in the drawings are not necessarily to scale, emphasis instead being placed upon illustrating the principles of the exemplary embodiments.

In the microelectronics industry, different manufacturers have overarching carrier substrate requirements (i.e., size, shape, etc.) that are somewhat uniform. However, the property specifications (i.e., coefficient of thermal expansion, elastic modulus, and the like) may differ from manufacturer to manufacturer or even from facility to facility. The wide array of property specifications for glass substrates in the microelectronics industry presents a unique challenge to manufacturers of glass substrates seeking to economically and efficiently mass produce such substrates compatible for use with different microelectronic carrier operations.

Compositions and methods described herein facilitate forming glass substrates that are compatible with the processes employed by various microelectronic device manufacturers, while allowing the properties such as CTE and Young's modulus, to be tuned to meet the specifications of individual manufacturers. Specifically, some embodiments described herein relate to glass compositions, articles formed from the glass compositions and methods for manufacturing glass articles having a high Young's modulus and a large CTE range.

### Laminated Glass Articles

In various embodiments, a laminated glass article comprises a core layer and at least one cladding (or clad) layer adjacent to the core layer. The core layer and the cladding layer are glass layers comprising glass compositions having different properties. The inventors discovered that the effective CTE of a glass composition varies with the ratio of mol. % of Al₂O₃ and B₂O₃ to modifier, and as such, adjusting the ratio can be an effective driver to change the CTE of a resultant glass laminate, as will be described in greater detail below. The concept of tunable CTE via laminate is attractive since the thickness of the core and clad layers can be modified to span an entire range of CTEs as needed for microelectronic carrier applications. The alternate approach is to make a single monolithic glass for each CTE that is desired, which is an expensive process requiring a large number of glass compositions. The glass compositions described herein can be used in a lamination process to provide tunable CTE and possess the high modulus that provide higher stiffness carriers. The CTE mismatch between core and cladding also results in strengthening which will reduce carrier breakage during processing.

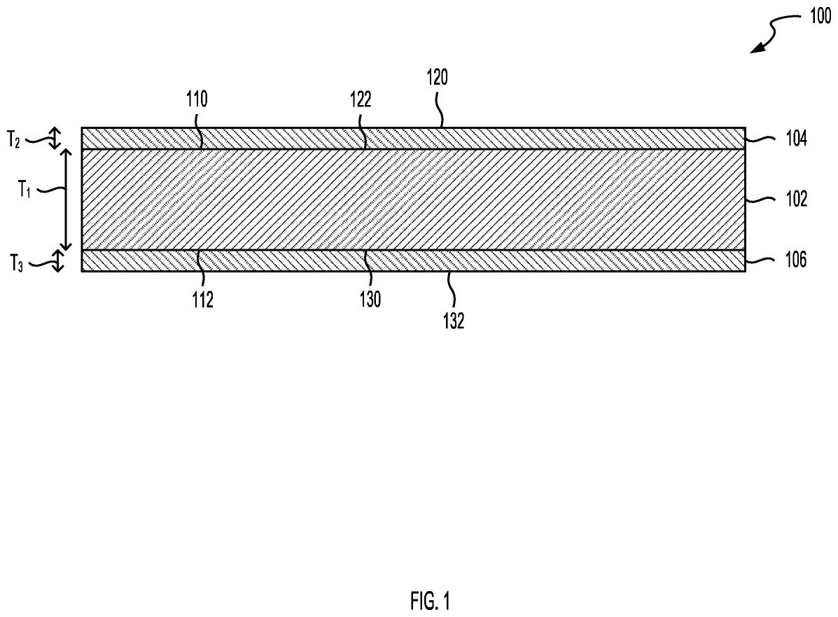

Referring to FIG. 1, by way of example, a cross section of a portion of a glass article 100 formed from the high Young's modulus and desired CTE glass compositions described herein is schematically depicted. The depicted portion of the glass article 100 has a glass core layer 102 coupled to a first or upper glass cladding layer 104 and a second or lower glass cladding layer 106. In various embodiments, a glass article comprises a glass core layer disposed between a first glass cladding layer and a second glass cladding layer. The glass article 100 includes multiple glass layers and can be considered a glass laminate. In some embodiments, the layers 102, 104, 106 are fused together without any adhesives, polymer layers, coating layers or the like positioned between them. In other embodiments, the layers 102, 104, 106 are coupled (e.g., adhered) together using adhesives or the like. The glass core layer 102 has a glass core layer first surface 110 and a glass core layer second surface 112 spaced apart by a thickness T₁ of the glass core layer 102. The first glass cladding layer 104 has a first glass cladding layer first surface 120 and a first glass cladding layer second surface 122 spaced apart by a thickness T₂ of the first glass cladding layer 104. The second glass cladding layer 106 has a second glass cladding layer first surface 130 and a second glass cladding layer second surface 132 spaced apart by a thickness T₃ of the second glass cladding layer 106.

The glass composition may be selected based on its CTE at a particular temperature or its average CTE over a temperature range (e.g., 0° C. to 400° C., 0° C. to 300° C., 0° C. to 260° C., 20° C. to 300° C., or 20° C. to 260° C.), its density, its Young's modulus, or other properties that may be desired for processing or use of the glass article 100. Suitably, the glass core layer 102 has a CTE between 8.0 and 10.0 ppm/° C. and a Young's modulus of between 79 GPa and 100 GPa, and glass cladding layers 104, 106 have a CTE between 3.5 and 5.5 ppm/° C. and a Young's modulus of between 79 GPa and 100 GPa, such as those described herein for the glass core compositions and glass cladding compositions.

In some embodiments, the glass article 100 is configured so that at least one of the glass cladding layers 104, 106 and the glass core layer 102 have different physical dimensions and/or physical properties that allow for selective removal of the at least one glass cladding layer 104, 106 relative to the glass core layer 102 to form precisely dimensioned cavities (not shown), which can be sized and shaped to receive microelectronic components.

In various embodiments, the glass article 100 is configured so that at least one of the glass cladding layers 104, 106 and the glass core layer 102 have different coefficients of thermal expansion (CTE). According to various embodiments described herein, at least one of the glass cladding layers 104, 106 is formed from a glass cladding composition and has an average cladding coefficient of thermal expansion CTE_{cladAvg} that is less than an average core coefficient of thermal expansion CTE_{coreAvg}. In such embodiments, a nearly uniform compressive stress forms across the thickness of the glass cladding layers 104, 106, with a balancing tensile stress within the glass core layer 102. Such glass laminates are mechanically strengthened, and can endure damages, such as damages that may occur during handling, better than non-strengthened glass articles, as will be described in greater detail below.

In various embodiments, the glass core layer 102 has a Young's modulus (Y_{core}) of at least 79 GPa, which may minimize flexing of the glass during processing and prevent damage to devices attached to the glass, such as when the glass is used as a carrier substrate for electronic devices. In some embodiments, the glass core layer 102 has a Young's modulus of greater than 79 GPa, greater than 85 GPa, greater than 90 GPa, greater than 95 GPa, or greater than 99 GPa. In some embodiments, the glass core layer 102 has a Young's modulus of less than 100 GPa, less than 95 GPa, less than 90 GPa, less than 85 GPa, or less than 80 GPa. In some particular embodiments, the glass core layer 102 has a Young's modulus from about 79 GPa to about 100 GPa, such as from about 80 GPa to about 100 GPa, from about 80 GPa to about 95 GPa, from about 80 GPa to about 90 GPa, from about 80 GPa to about 85 GPa, from 85 GPa to about 100 GPa, from about 85 GPa to about 95 GPa, from about 85 GPa to about 90 GPa, from 90 GPa to about 100 GPa, from about 90 GPa to about 95 GPa, from 95 GPa to about 100 GPa, or any range including and/or in-between any two of these values. However, it is contemplated that desired properties, including the Young's modulus, may vary depending on the particular embodiment, end use, and processing requirements for the glass core layer 102.

In various embodiments, the glass core layer 102 has a coefficient of thermal expansion (CTE_{core}) between 8.0 ppm/° C. and 10.0 ppm/° C. In some embodiments the CTE_{core} is from about 8.0 ppm/° C. to about 10.0 ppm/° C., such as from about 8.0 ppm/° C. to about 9.5 ppm/° C., from about 8.0 ppm/° C. to about 9.0 ppm/° C., from about 8.0 ppm/° C. to about 8.5 ppm/° C., from about 8.5 ppm/° C. to about 10.0 ppm/° C., from about 8.5 ppm/° C. to about 9.5 ppm/° C., from about 8.5 ppm/° C. to about 9.0 ppm/° C., from about 9.0 ppm/° C. to about 10.0 ppm/° C., from about 9.0 ppm/° C. to about 9.5 ppm/° C., from about 9.5 ppm/° C. to about 10.0 ppm/° C., or any range including and/or in-between any two of these values.

In various embodiments, the glass cladding layers 104, 106 have a Young's modulus (Y_{clad}) of at least 79 GPa, which may minimize flexing of the glass during processing and prevent damage to devices attached to the glass, such as when the glass is used as a carrier substrate for electronic devices. In some embodiments, the glass cladding layers 104, 106 have a Young's modulus of greater than 79 GPa, greater than 85 GPa, greater than 90 GPa, greater than 95 GPa, or greater than 99 GPa. In some embodiments, the glass cladding layers 104, 106 have a Young's modulus of less than 100 GPa, less than 95 GPa, less than 90 GPa, less than 85 GPa, or less than 80 GPa. In some particular embodiments, the glass cladding layers 104, 106 have a Young's modulus from about 79 GPa to about 100 GPa, such as from about 80 GPa to about 100 GPa, from about 80 GPa to about 95 GPa, from about 80 GPa to about 90 GPa, from about 80 GPa to about 85 GPa, from 85 GPa to about 100 GPa, from about 85 GPa to about 95 GPa, from about 85 GPa to about 90 GPa, from 90 GPa to about 100 GPa, from about 90 GPa to about 95 GPa, from 95 GPa to about 100 GPa, or any range including and/or in-between any two of these values. However, it is contemplated that desired properties, including the Young's modulus, may vary depending on the particular embodiment, end use, and processing requirements for the glass cladding layers 104, 106.

In various embodiments, the glass cladding layers 104, 106 have a coefficient of thermal expansion (CTE_{clad}) between 3.5 ppm/° C. and 5.5 ppm/° C. In some embodiments the CTE_{core} is from about 3.5 ppm/° C. to about 5.5 ppm/° C., such as from about 3.5 ppm/° C. to about 5.0 ppm/° C., from about 3.5 ppm/° C. to about 4.5 ppm/° C., from about 3.5 ppm/° C. to about 4.0 ppm/° C., from about 4.0 ppm/° C. to about 5.5 ppm/° C., from about 4.0 ppm/° C. to about 5.0 ppm/° C., from about 4.0 ppm/° C. to about 4.5 ppm/° C., from about 4.5 ppm/° C. to about 5.5 ppm/° C., from about 4.5 ppm/° C. to about 5.0 ppm/° C., from about 5.0 ppm/° C. to about 5.5 ppm/° C., or any range including and/or in-between any two of these values.

In various embodiments, the thickness of the layers 102, 104, 106 can vary widely in the glass article 100. For example, the layers 102, 104, 106 can all have the same thickness or different thicknesses or two of the layers can be the same thickness while the third layer has a different thickness.

In some embodiments, one or both of the glass cladding layers 104, 106 are each 5 microns to 300 microns thick, 10 microns to 275 microns thick, or 12 microns to 250 microns thick. In other embodiments, one or both of the glass cladding layers 104, 106 are each greater than 5 microns thick, greater than 10 microns thick, greater than 12 microns thick, greater than 15 microns thick, greater than 20 microns thick, greater than 25 microns thick, greater than 30 microns thick, greater than 40 microns thick, greater than 50 microns thick, greater than 60 microns thick, greater than 70 microns thick, greater than 80 microns thick, greater than 90 microns thick, greater than 100 microns thick, greater than 125 microns thick, greater than 150 microns thick, greater than 175 microns thick, or greater than 200 microns thick. In other embodiments, one or both of the glass cladding layers 104, 106 are each less than 300 microns thick, less than 275 microns thick, less than 250 microns thick, less than 225 microns thick, less than 200 microns thick, less than 175 microns thick, less than 150 microns thick, less than 125 microns thick, or less than 100 microns thick. It should be appreciated, however, that the glass cladding layers 104, 106 can have other thicknesses.

In some embodiments, the glass core layer 102 has a thickness of from 300 microns to 1200 microns, or from 600 microns to 1100 microns. In other embodiments, the glass core layer 102 has a thickness of greater than 300 microns, greater than 500 microns, greater than 600 microns, greater than 700 microns, greater than 800 microns, greater than 900 microns. In other embodiments, the glass core layer 102 has a thickness of less than 1200 microns, less than 1100 microns, less than 1000 microns, less than 900 microns, or less than 800 microns. It should be appreciated, however, that the glass core layer 102 can have other thicknesses.

In various embodiments, a ratio of the thickness of the glass core layer (T₁) to the total thickness of the glass cladding layers (sum of T₂ and T₃) is greater than 1 and less than 50, or greater than 1.75 and less than 10. In some embodiments, the ratio is greater than 1, greater than 2, greater than 2.5, greater than 3, greater than 4, or greater than 5. In embodiments, the ratio is less than 50, less than 20, less than 10, less than 9, less than 8, less than 7, less than 6, less than 5, or less than 4. It should be appreciated, however, that glass substrate can have another ratio of the thickness of the glass core layer to the total thickness of the glass cladding layers.

In various embodiments, the glass article 100 has a coefficient of thermal expansion (CTE_{article}) between 3.5 ppm/° C. and 10.0 ppm/° C. In some embodiments, the CTE_{article} is from about 3.5 ppm/° C. to about 10.0 ppm/° C., such as from about 3.5 ppm/° C. to about 9.5 ppm/° C., from about 3.5 ppm/° C. to about 8.0 ppm/° C., from about 3.5 ppm/° C. to about 6.0 ppm/° C., from about 3.5 ppm/° C. to about 4.0 ppm/° C., from about 4.0 ppm/° C. to about 10.0 ppm/° C., from about 4.0 ppm/° C. to about 9.5 ppm/° C., from about 4.0 ppm/° C. to about 8.0 ppm/° C., from about 4.0 ppm/° C. to about 6.0 ppm/° C., from about 6.0 ppm/° C. to about 10.0 ppm/° C., from about 6.0 ppm/° C. to about 9.5 ppm/° C., from about 6.0 ppm/° C. to about 8.0 ppm/° C., from about 8.0 ppm/° C. to about 10.0 ppm/° C., from about 8.0 ppm/° C. to about 9.5, ppm/° C., from about 8.0 ppm/° C. to about 9.5 ppm/° C., or any range including and/or in-between any two of these values.

In various embodiments, the glass article 100 has a Young's modulus (Y_{article}) of at least 79 GPa, which may minimize flexing of the glass during processing and prevent damage to devices attached to the glass, such as when the glass is used as a carrier substrate for electronic devices. In some embodiments, the glass article 100 has a Young's modulus of greater than 79 GPa, greater than 85 GPa, greater than 90 GPa, greater than 95 GPa, or greater than 99 GPa. In some embodiments, the glass article 100 has a Young's modulus of less than 100 GPa, less than 95 GPa, less than 90 GPa, less than 85 GPa, or less than 80 GPa. In some particular embodiments, the glass article 100 has a Young's modulus from about 79 GPa to about 100 GPa, such as from about 80 GPa to about 100 GPa, from about 80 GPa to about 95 GPa, from about 80 GPa to about 90 GPa, from about 80 GPa to about 85 GPa, from 85 GPa to about 100 GPa, from about 85 GPa to about 95 GPa, from about 85 GPa to about 90 GPa, from 90 GPa to about 100 GPa, from about 90 GPa to about 95 GPa, from 95 GPa to about 100 GPa, or any range including and/or in-between any two of these values. However, it is contemplated that desired properties, including the Young's modulus, may vary depending on the particular embodiment, end use, and processing requirements for the glass article 100.

Another aspect of the glass article 100 that can vary widely is the glass composition of the layers 102, 104, 106. For example, the layers 102, 104, 106 can all have different glass compositions or two of the layers can have the same glass composition while the third layer has a different glass composition. In general, one or both of the glass cladding layers 104, 106 have a glass composition that is different from the glass composition of the glass core layer 102, as described in detail below.

### Core Layer Compositions

The core glass compositions of the present technology have both high Young's modulus and high coefficient of thermal expansion. Typically, it is difficult to obtain both high CTE and high Young's modulus since the most common way is to achieve either property is by using different modifier ions with different cation field strength. Cation field strength, F, is defined using the following equation:

F=Z_{C}/(r_{C}+r_{O})²

where Z_{c} is the charge on the cation, r_{c} is the radius of the cation, and rₒ is the radius of the oxygen anion. The cation field strength of modifiers is in the following order from lowest to highest: K, Na, Li, Ba, Sr, Ca, Mg. To achieve high CTE, the general approach is to utilize a low field strength modifiers such as K. To achieve high Young's modulus, the general approach is to utilize high field strength modifiers such as Ca or Mg. However, this general approach to glass design is not useful for obtaining both high Young's modulus and high CTE, because typically, Young's modulus and CTE are properties that do not trend in the same direction with compositional changes.

The inventors of the present technology discovered that starting from non-exotic and relatively cheap glass components including SiO₂, Al₂O₃, B₂O₃, Na₂O, and CaO and using novel approach of modifying the coordination of boron to be tetrahedral to achieve high Young's modulus rather than by simply using high field strength modifiers, unique glass compositions having both high CTE and high Young's modulus can be obtained. However, the core compositions of the present technology achieve both high Young's modulus (e.g., higher than about 80 GPa) and high CTE values (e.g., higher than about 8.0 ppm/° C.).

The glass compositions for the core layer (core glass) may include a base composition which is essentially an aluminoborosilicate. Thus, the base compositions of the core layer glass may generally include a combination of SiO₂, Al₂O₃, and B₂O₃. The core glass compositions may further include at least one alkaline earth oxides such as CaO. The core glass compositions may include at least one alkali metal oxides, such as Na₂O, and K₂O. In some embodiments, the core glass composition may further include one or more additional oxides, such as, by way of example and not limitation, Y₂O₃, La₂O₃, ZrO₂, TiO₂, BeO or Ta₂O₅ or the like. The core glass compositions may generally include a combination of SiO₂, Al₂O₃, B₂O₃, and a modifier, wherein the modifier is at least one of Na₂O, K₂O and CaO. The modifier can include an alkali metal oxide such as Na₂O and K₂O, or an alkaline earth metal oxide such as CaO. The glass compositions described in this section can be used to form a glass core layer 102 described in further detail herein.

In various embodiments, the core glass composition generally includes SiO₂ in an amount from about 50 mol. % to about 70 mol. %. When the content of SiO₂ is too small, the glass may have poor chemical and mechanical durability. On the other hand, when the content of SiO₂ is too large, melting ability of the glass decreases and the viscosity increases, so forming of the glass becomes difficult. In some embodiments, SiO₂ is present in the core glass composition in an amount from about 50 mol. % to about 70 mol. %, such as from about 50 mol. % to about 65 mol. %, from about 50 mol. % to about 60 mol. %, from about 50 mol. % to about 55 mol. %, from about 55 mol. % to about 70 mol. %, from about 55 mol. % to about 65 mol. %, from about 55 mol. % to about 60 mol. %, from about 60 mol. % to about 70 mol. %, from about 60 mol. % to about 65 mol. %, or from about 65 mol. % to about 70 mol. %, or any range including and/or in-between any two of these values. For example, SiO₂ is present in the core glass composition in an amount from about 55 mol. % to about 60 mol. %, or from about 55 mol. % to about 65 mol. %.

The core glass compositions may also include Al₂O₃. Al₂O₃, in conjunction with alkali oxides present in the glass composition, such as Na₂O, K₂O or the like, improves the susceptibility of the glass to ion exchange strengthening. Moreover, increased amounts of Al₂O₃ may also increase the softening point of the glass, thereby reducing the formability of the glass. The core glass compositions described herein may include Al₂O₃ in an amount from about 0.1 mol. % to about 10 mol. %, such as from about 0.1 mol. % to about 8 mol. %, from about 0.1 mol. % to about 6 mol. %, from about 0.1 mol. % to about 4 mol. %, from about 0.1 mol. % to about 2 mol. %, from about 2 mol. % to about 10 mol. %, from about 2 mol. % to about 8 mol. %, from about 2 mol. % to about 6 mol. %, from about 2 mol. % to about 4 mol. %, from about 4 mol. % to about 10 mol. %, from about 4 mol. % to about 8 mol. %, from about 4 mol. % to about 6 mol. %, from about 6 mol. % to about 10 mol. %, from about 6 mol. % to about 8 mol. %, from about 8 mol. % to about 10 mol. %, or any range including and/or in-between any two of these values. For example, Al₂O₃ is present in the core glass composition in an amount from about 0.1 mol. % to about 4 mol. %.

In some embodiments described herein, the boron concentration in the core glass compositions is a flux which may be added to glass compositions to make the viscosity-temperature curve less steep as well as lowering the entire curve, thereby improving the formability of the glass and softening the glass. In various embodiments, the core glass compositions include from about 5 mol. % B₂O₃ to about 25 mol. % B₂O₃, such as from about 5 mol. % B₂O₃ to about 20 mol. % B₂O₃, from about 5 mol. % B₂O₃ to about 15 mol. % B₂O₃, from about 5 mol. % B₂O₃ to about 10 mol. % B₂O₃, from about 10 mol. % B₂O₃ to about 25 mol. % B₂O₃, from about 10 mol. % B₂O₃ to about 20 mol. % B₂O₃, from about 10 mol. % B₂O₃ to about 15 mol. % B₂O₃, from about 15 mol. % B₂O₃ to about 25 mol. % B₂O₃, from about 15 mol. % B₂O₃ to about 20 mol. % B₂O₃, from about 20 mol. % B₂O₃ to about 25 mol. % B₂O₃, or any range including and/or in-between any two of these values. For example, B₂O₃ is present in the core glass composition in an amount from about 15 mol. % to about 20 mol. %.

In various embodiments, the core glass composition generally includes a modifier. The modifier is at least one of Na₂O, K₂O and CaO. When modifiers are added to glasses, the modifiers are preferentially consumed in a charge compensating role by Al³⁺ ions so they act as Al⁴⁺ ions and substitute directly into the Si⁴⁺ network. The modifiers in excess of Al ions can charge compensate B³⁺ so it acts as B⁴⁺. The modifiers change the boron coordination from trigonal to tetrahedral. Trigonal boron units lower the Young's modulus of a glass, while more highly coordinated tetrahedral units raise the modulus of the glass. In various embodiments, the modifier includes Na₂O and CaO. Thus, the modifiers used in the glass compositions described herein impact the configuration of Boron and consequently various properties, such as the Young's modulus, of the glass compositions. In various embodiments, the modifier includes Na₂O, K₂O and CaO. In various embodiments, the core glass compositions include from about 10 mol. % modifier to about 30 mol. % modifier, such as from 10 mol. % modifier to about 25 mol. % modifier, from 10 mol. % modifier to about 20 mol. % modifier, from 10 mol. % modifier to about 15 mol. % modifier, from 15 mol. % modifier to about 30 mol. % modifier, from 15 mol. % modifier to about 25 mol. % modifier, from 15 mol. % modifier to about 20 mol. % modifier, from 20 mol. % modifier to about 30 mol. % modifier, from 20 mol. % modifier to about 25 mol. % modifier, from 25 mol. % modifier to about 30 mol. % modifier, or any range including and/or in-between any two of these values. For example, Na₂O is present in the core glass composition in an amount from about 13 mol. % to about 23 mol. %, or from about 5 mol. % to about 13 mol. %. For example, CaO is present in the core glass composition in an amount from about 0 mol. % to about 10 mol. %, or from about 5 mol. % to about 13 mol. %. For example, K₂O is present in the core glass composition in an amount from about 0.1 mol. % to about 4 mol. %.

The core glass compositions are such that 0.95<(Al₂O₃+B₂O₃)/(NaO+CaO)<1.05. In various embodiments, the ratio of mol. % of Al₂O₃ and B₂O₃ to modifier is from about 0.95 to about 1.05, such as from about 0.95 to about 1.03, from about 0.95 to about 1, from about 0.95 to about 0.97, from about 0.97 to about 1.05, from about 0.97 to about 1.03, from about 0.97 to about 1, from about 1 to about 1.05, from about 1 to about 1.03, from about 1.03 to about 1.05, or any range including and/or in-between any two of these values.

In various embodiments, the ratio of mol. % of Al₂O₃ and B₂O₃ to Na₂O and CaO is from about 0.95 to about 1.05, such as from about 0.95 to about 1.03, from about 0.95 to about 1, from about 0.95 to about 0.97, from about 0.97 to about 1.05, from about 0.97 to about 1.03, from about 0.97 to about 1, from about 1 to about 1.05, from about 1 to about 1.03, from about 1.03 to about 1.05, or any range including and/or in-between any two of these values.

In various embodiments, the ratio of mol. % of Al₂O₃ and B₂O₃ to Na₂O, K₂O and CaO is from about 0.95 to about 1.05, such as from about 0.95 to about 1.03, from about 0.95 to about 1, from about 0.95 to about 0.97, from about 0.97 to about 1.05, from about 0.97 to about 1.03, from about 0.97 to about 1, from about 1 to about 1.05, from about 1 to about 1.03, from about 1.03 to about 1.05, or any range including and/or in-between any two of these values.

In various embodiments, the core glass compositions include from about 0 mol. % Y₂O₃ to about 3 mol. % Y₂O₃, such as from about 0 mol. % Y₂O₃ to about 2 mol. % Y₂O₃, from about 0 mol. % Y₂O₃ to about 1 mol. % Y₂O₃, from about 1 mol. % Y₂O₃ to about 3 mol. % Y₂O₃, from about 1 mol. % Y₂O₃ to about 2 mol. % Y₂O₃, or from about 2 mol. % Y₂O₃ to about 3 mol. % Y₂O₃, or any range including and/or in-between any two of these values. In some embodiments, the core glass compositions may be free from yttrium and compounds containing yttrium.

In various embodiments, the core glass compositions include from about 0 mol. % La₂O₃ to about 3 mol. % La₂O₃, such as from about 0 mol. % La₂O₃ to about 2 mol. % La₂O₃, from about 0 mol. % La₂O₃ to about 1 mol. % La₂O₃, from about 1 mol. % La₂O₃ to about 3 mol. % La₂O₃, from about 1 mol. % La₂O₃ to about 2 mol. % La₂O₃, or from about 2 mol. % La₂O₃ to about 3 mol. % La₂O₃, or any range including and/or in-between any two of these values. In some embodiments, the core glass compositions may be free from lanthanum and compounds containing lanthanum.

In various embodiments, the core glass compositions include from about 0 mol. % ZrO₂ to about 3 mol. % ZrO₂, such as from about 0 mol. % ZrO₂ to about 2 mol. % ZrO₂, from about 0 mol. % ZrO₂ to about 1 mol. % ZrO₂, from about 1 mol. % ZrO₂ to about 3 mol. % ZrO₂, from about 1 mol. % ZrO₂ to about 2 mol. % ZrO₂, or from about 2 mol. % ZrO₂ to about 3 mol. % ZrO₂, or any range including and/or in-between any two of these values. In some embodiments, the core glass compositions may be free from zirconium and compounds containing zirconium.

In various embodiments, the core glass compositions include from about 0 mol. % TiO₂ to about 3 mol. % TiO₂, such as from about 0 mol. % TiO₂ to about 2 mol. % TiO₂, from about 0 mol. % TiO₂ to about 1 mol. % TiO₂, from about 1 mol. % TiO₂ to about 3 mol. % TiO₂, from about 1 mol. % TiO₂ to about 2 mol. % TiO₂, or from about 2 mol. % TiO₂ to about 3 mol. % TiO₂, or any range including and/or in-between any two of these values. In some embodiments, the core glass compositions may be free from titanium and compounds containing titanium.

In various embodiments, the core glass compositions include from about 0 mol. % BeO to about 3 mol. % BeO, such as from about 0 mol. % BeO to about 2 mol. % BeO, from about 0 mol. % BeO to about 1 mol. % BeO, from about 1 mol. % BeO to about 3 mol. % BeO, from about 1 mol. % BeO to about 2 mol. % BeO, or from about 2 mol. % BeO to about 3 mol. % BeO, or any range including and/or in-between any two of these values. In some embodiments, the core glass compositions may be free from beryllium and compounds containing beryllium.

In various embodiments, the core glass compositions include from about 0 mol. % Ta₂O₅ to about 3 mol. % Ta₂O₅, such as from about 0 mol. % Ta₂O₅ to about 2 mol. % Ta₂O₅, from about 0 mol. % Ta₂O₅ to about 1 mol. % Ta₂O₅, from about 1 mol. % Ta₂O₅ to about 3 mol. % Ta₂O₅, from about 1 mol. % Ta₂O₅ to about 2 mol. % Ta₂O₅, or from about 2 mol. % Ta₂O₅ to about 3 mol. % Ta₂O₅, or any range including and/or in-between any two of these values. In some embodiments, the core glass compositions may be free from tantalum and compounds containing tantalum.

In some embodiments, the core glass composition can include from about 55 mol. % SiO₂ to about 60 mol. % SiO₂, from about 0.1 mol. % to about 4 mol. % Al₂O₃, from about 15 mol. % B₂O₃ to about 20 mol. % B₂O₃, from about 13 mol. % Na₂O to about 23 mol. % Na₂O, from about 0 mol. % CaO to about 10 mol. % CaO, The ratio of mol. % of Al₂O₃ and B₂O₃ to Na₂O and CaO is from about 0.95 to about 1.05. The core glass composition can have a Young's modulus from about 70 GPa to about 85 GPa. The core glass composition can have a CTE from about 8.0 ppm/° C. to 10.0 ppm/° C.

In other embodiments, the core glass composition can include from about 55 mol. % SiO₂ to about 65 mol. % SiO₂, from about 0.1 mol. % to about 4 mol. % Al₂O₃, from about 15 mol. % B₂O₃ to about 20 mol. % B₂O₃, from about 5 mol. % Na₂O to about 13 mol. % Na₂O, from about 0.1 mol. % K₂O to about 4 mol. % K₂O, from about 5 mol. % CaO to about 13 mol. % CaO, The ratio of mol. % of Al₂O₃ and B₂O₃ to Na₂O, K₂O and CaO is from about 0.95 to about 1.05. The core glass composition can have a Young's modulus from about 79 GPa to about 83 GPa. The core glass composition can have a CTE from about 6.0 ppm/° C. to 8.0 ppm/° C.

In various embodiments, the glass composition has a Young's modulus of at least 79 GPa, which may minimize flexing of the glass during processing and prevent damage to devices attached to the glass, such as when the glass is used as a carrier substrate for microelectronic devices. In some embodiments, the core glass composition has a Young's modulus of greater than 79 GPa, greater than 85 GPa, greater than 90 GPa, greater than 95 GPa, or greater than 99 GPa. In some embodiments, the glass composition has a Young's modulus of less than 100 GPa, less than 95 GPa, less than 90 GPa, less than 85 GPa, or less than 80 GPa. In some particular embodiments, the core glass composition has a Young's modulus from about 79 GPa to about 100 GPa, such as from about 80 GPa to about 100 GPa, from about 80 GPa to about 95 GPa, from about 80 GPa to about 90 GPa, from about 80 GPa to about 85 GPa, from 85 GPa to about 100 GPa, from about 85 GPa to about 95 GPa, from about 85 GPa to about 90 GPa, from 90 GPa to about 100 GPa, from about 90 GPa to about 95 GPa, from 95 GPa to about 100 GPa, or any range including and/or in-between any two of these values. However, it is contemplated that desired properties, including the Young's modulus, may be varied depending on the particular embodiment, end use, and processing requirements for the glass composition.

In various embodiments, the core glass composition has a coefficient of thermal expansion between 8.0 ppm/° C. and 10.0 ppm/° C. In some embodiments the CTE is from about 8.0 ppm/° C. to about 10.0 ppm/° C., such as from about 8.0 ppm/° C. to about 9.5 ppm/° C., from about 8.0 ppm/° C. to about 9.0 ppm/° C., from about 8.0 ppm/° C. to about 8.5 ppm/° C., from about 8.5 ppm/° C. to about 10.0 ppm/° C., from about 8.5 ppm/° C. to about 9.5 ppm/° C., from about 8.5 ppm/° C. to about 9.0 ppm/° C., from about 9.0 ppm/° C. to about 10.0 ppm/° C., from about 9.0 ppm/° C. to about 9.5 ppm/° C., from about 9.5 ppm/° C. to about 10.0 ppm/° C., or any range including and/or in-between any two of these values.

In some embodiments, the core glass compositions each have a liquidus viscosity suitable for forming the glass article using a fusion draw process as described herein. For example, each of the core glass compositions may have a liquidus viscosity of at least about 5 kP at least about 50 kP, at least about 100 kP, or at least about 200 kP. Additionally or alternatively, each of the core glass compositions comprises a liquidus viscosity of less than about 3000 kP, less than about 2000 kP, less than about 1000 kP, less than about 500 kP, less than about 200 kP, less than about 100 kP or less than about 75 kP. In some embodiments, the core glass layer may have a liquidus viscosity from about 5 kP to about 3000 kP, such as from about 5 kP to about 2000 kP, about 100 kP to about 1500 kP, about 200 kP to about 1000 kP, about 500 kP to about 800 kP, about 5 kP to about 100 kP, or about 5 kP to about 75 kP, or any range including and/or in-between any two of these values. In some embodiments, the core glass compositions may have a liquidus viscosity of from about 5 kP to about 75 kP.

The core and cladding glass compositions of the present disclosure advantageously possess high Young's modulus, a desired CTE, and improved durability while maintaining the melting and forming properties of the glass. The glass compositions may optionally include additional components useful in modifying the physical and chemical properties of the glass, e.g., refractive index, glass stability, chemical durability, etc. For example, in various embodiments, the inclusion of one or more alkali oxides in the glass compositions can enable the glass compositions to be ion exchanged according to methods known and used in the art. In some embodiments, the glass composition is chemically strengthened through an ion exchange process. Ion exchanging may further strengthen the glass composition and alter the stresses in the glass article formed from the glass composition. However, in some embodiments, the glass article formed from the glass composition is not ion exchanged, since ion exchange may result in dimensional changes or warpage of the glass article.

### Cladding Layer Compositions

The glass compositions for the cladding layer may include a base composition which is essentially an aluminoborosilicate. Thus, the base compositions of the cladding glass may generally include a combination of SiO₂, Al₂O₃, and B₂O₃. The glass compositions may further include at least one alkaline earth oxides such as MgO and CaO. The cladding glass compositions may include at least one alkali metal oxides, such as Na₂O, and K₂O. In some embodiments, the cladding glass composition may further include one or more additional oxides, such as, by way of example and not limitation, Y₂O₃, La₂O₃, ZrO₂, TiO₂, BeO or Ta₂O₅ or the like. The cladding glass compositions may generally include a combination of SiO₂, Al₂O₃, B₂O₃, and a modifier, wherein the modifier is at least one of MgO and CaO. The modifier for the cladding glass layer can include an alkaline earth metal oxide such as MgO and CaO. The glass compositions described in this section can be used to form a glass cladding layer 104 described in further detail herein.

In various embodiments, the cladding glass composition generally includes SiO₂ in an amount from about 40 mol. % to about 65 mol. %. When the content of SiO₂ is too small, the glass may have poor chemical and mechanical durability. On the other hand, when the content of SiO₂ is too large, melting ability of the glass decreases and the viscosity increases, so forming of the glass becomes difficult. In some embodiments, SiO₂ is present in the cladding glass composition in an amount from about 40 mol. % to about 65 mol. %, such as from about 40 mol. % to about 60 mol. %, from about 40 mol. % to about 55 mol. %, from about 40 mol. % to about 50 mol. %, from about 40 mol. % to about 45 mol. %, from about 45 mol. % to about 65 mol. %, from about 45 mol. % to about 60 mol. %, from about 45 mol. % to about 55 mol. %, from about 45 mol. % to about 50 mol. %, from about 50 mol. % to about 65 mol. %, from about 50 mol. % to about 60 mol. %, from about 50 mol. % to about 55 mol. %, from about 55 mol. % to about 65 mol. %, from about 55 mol. % to about 60 mol. %, from about 60 mol. % to about 65 mol. %, or any range including and/or in-between any two of these values. For example, SiO₂ is present in the cladding glass composition in an amount from about 40 mol. % to about 60 mol. %, or from about 55 mol. % to about 65 mol. %.

The cladding glass compositions may also include Al₂O₃. Al₂O₃, in conjunction with alkali oxides present in the glass composition, such as Na₂O, K₂O or the like, improves the susceptibility of the glass to ion exchange strengthening. Moreover, increased amounts of Al₂O₃ may also increase the softening point of the glass, thereby reducing the formability of the glass. The cladding glass compositions described herein may include Al₂O₃ in an amount from about 0.1 mol. % to about 20 mol. %, such as from about 0.1 mol. % to about 15 mol. %, from about 0.1 mol. % to about 10 mol. %, from about 0.1 mol. % to about 5 mol. %, from about 5 mol. % to about 20 mol. %, from about 5 mol. % to about 15 mol. %, from about 5 mol. % to about 10 mol. %, from about 10 mol. % to about 20 mol. %, from about 10 mol. % to about 15 mol. %, from about 15 mol. % to about 20 mol. %, or any range including and/or in-between any two of these values. For example, Al₂O₃ is present in the cladding glass composition in an amount from about 7 mol. % to about 17 mol. %, or from about 0.1 mol. % to about 4 mol. %.

In some embodiments described herein, boron may be added to the cladding glass compositions to make the viscosity-temperature curve less steep as well as lowering the entire curve, thereby improving the formability of the glass and softening the glass. In various embodiments, the cladding glass compositions include from about 5 mol. % B₂O₃ to about 25 mol. % B₂O₃, such as from about 5 mol. % B₂O₃ to about 20 mol. % B₂O₃, from about 5 mol. % B₂O₃ to about 15 mol. % B₂O₃, from about 5 mol. % B₂O₃ to about 10 mol. % B₂O₃, from about 10 mol. % B₂O₃ to about 25 mol. % B₂O₃, from about 10 mol. % B₂O₃ to about 20 mol. % B₂O₃, from about 10 mol. % B₂O₃ to about 15 mol. % B₂O₃, from about 15 mol. % B₂O₃ to about 25 mol. % B₂O₃, from about 15 mol. % B₂O₃ to about 20 mol. % B₂O₃, from about 20 mol. % B₂O₃ to about 25 mol. % B₂O₃, or any range including and/or in-between any two of these values. For example, B₂O₃ is present in the cladding glass composition in an amount from about 4 mol. % to about 20 mol. %, or from about 15 mol. % to about 20 mol. %.

In various embodiments, the cladding glass composition generally includes a modifier. The modifier is at least one of MgO and CaO. In various embodiments, the cladding glass compositions include from about 10 mol. % modifier to about 40 mol. % modifier, such as from 10 mol. % modifier to about 35 mol. % modifier, from 10 mol. % modifier to about 25 mol. % modifier, from 10 mol. % modifier to about 20 mol. % modifier, from 10 mol. % modifier to about 15 mol. % modifier, from about 15 mol. % modifier to about 40 mol. % modifier, from 15 mol. % modifier to about 35 mol. % modifier, from 15 mol. % modifier to about 25 mol. % modifier, from 15 mol. % modifier to about 20 mol. % modifier, from about 20 mol. % modifier to about 40 mol. % modifier, from 20 mol. % modifier to about 35 mol. % modifier, from 20 mol. % modifier to about 25 mol. % modifier, from about 25 mol. % modifier to about 40 mol. % modifier, from 25 mol. % modifier to about 35 mol. % modifier, from about 35 mol. % modifier to about 40 mol. % modifier, or any range including and/or in-between any two of these values. For example, MgO is present in the cladding glass composition in an amount from about 0 mol. % to about 23 mol. %, or from about 10 mol. % to about 23 mol. %. For example, CaO is present in the core glass composition in an amount from about 5 mol. % to about 23 mol. %, or from about 5 mol. % to about 13 mol. %. For example, K₂O is present in the core glass composition in an amount from about 0.1 mol. % to about 4 mol. %.

In various embodiments, the cladding glass compositions include from about 0 mol. % Y₂O₃ to about 3 mol. % Y₂O₃, such as from about 0 mol. % Y₂O₃ to about 2 mol. % Y₂O₃, from about 0 mol. % Y₂O₃ to about 1 mol. % Y₂O₃, from about 1 mol. % Y₂O₃ to about 3 mol. % Y₂O₃, from about 1 mol. % Y₂O₃ to about 2 mol. % Y₂O₃, or from about 2 mol. % Y₂O₃ to about 3 mol. % Y₂O₃, or any range including and/or in-between any two of these values. In some embodiments, the cladding glass compositions may be free from yttrium and compounds containing yttrium.

In various embodiments, the cladding glass compositions include from about 0 mol. % La₂O₃ to about 3 mol. % La₂O₃, such as from about 0 mol. % La₂O₃ to about 2 mol. % La₂O₃, from about 0 mol. % La₂O₃ to about 1 mol. % La₂O₃, from about 1 mol. % La₂O₃ to about 3 mol. % La₂O₃, from about 1 mol. % La₂O₃ to about 2 mol. % La₂O₃, or from about 2 mol. % La₂O₃ to about 3 mol. % La₂O₃, or any range including and/or in-between any two of these values. In some embodiments, the cladding glass compositions may be free from lanthanum and compounds containing lanthanum.

In various embodiments, the cladding glass compositions include from about 0 mol. % ZrO₂ to about 3 mol. % ZrO₂, such as from about 0 mol. % ZrO₂ to about 2 mol. % ZrO₂, from about 0 mol. % ZrO₂ to about 1 mol. % ZrO₂, from about 1 mol. % ZrO₂ to about 3 mol. % ZrO₂, from about 1 mol. % ZrO₂ to about 2 mol. % ZrO₂, or from about 2 mol. % ZrO₂ to about 3 mol. % ZrO₂, or any range including and/or in-between any two of these values. In some embodiments, the cladding glass compositions may be free from zirconium and compounds containing zirconium.

In various embodiments, the cladding glass compositions include from about 0 mol. % TiO₂ to about 3 mol. % TiO₂, such as from about 0 mol. % TiO₂ to about 2 mol. % TiO₂, from about 0 mol. % TiO₂ to about 1 mol. % TiO₂, from about 1 mol. % TiO₂ to about 3 mol. % TiO₂, from about 1 mol. % TiO₂ to about 2 mol. % TiO₂, or from about 2 mol. % TiO₂ to about 3 mol. % TiO₂, or any range including and/or in-between any two of these values. In some embodiments, the cladding glass compositions may be free from titanium and compounds containing titanium.

In various embodiments, the cladding glass compositions include from about 0 mol. % BeO to about 3 mol. % BeO, such as from about 0 mol. % BeO to about 2 mol. % BeO, from about 0 mol. % BeO to about 1 mol. % BeO, from about 1 mol. % BeO to about 3 mol. % BeO, from about 1 mol. % BeO to about 2 mol. % BeO, or from about 2 mol. % BeO to about 3 mol. % BeO, or any range including and/or in-between any two of these values. In some embodiments, the cladding glass compositions may be free from beryllium and compounds containing beryllium.

In various embodiments, the cladding glass compositions include from about 0 mol. % Ta₂O₅ to about 3 mol. % Ta₂O₅, such as from about 0 mol. % Ta₂O₅ to about 2 mol. % Ta₂O₅, from about 0 mol. % Ta₂O₅ to about 1 mol. % Ta₂O₅, from about 1 mol. % Ta₂O₅ to about 3 mol. % Ta₂O₅, from about 1 mol. % Ta₂O₅ to about 2 mol. % Ta₂O₅, or from about 2 mol. % Ta₂O₅ to about 3 mol. % Ta₂O₅, or any range including and/or in-between any two of these values. In some embodiments, the cladding glass compositions may be free from tantalum and compounds containing tantalum.

In some embodiments, the cladding glass composition can include from about 40 mol. % SiO₂ to about 60 mol. % SiO₂, from about 7 mol. % to about 17 mol. % Al₂O₃, from about 4 mol. % B₂O₃ to about 20 mol. % B₂O₃, from about 0 mol. % MgO to about 23 mol. % Na₂O, from about 5 mol. % CaO to about 23 mol. % CaO, The cladding glass composition can have a Young's modulus from about 80 GPa to about 95 GPa. The cladding glass composition can have a CTE from about 4.0 ppm/° C. to 6.0 ppm/° C.

In other embodiments, the cladding glass composition can include from about 55 mol. % SiO₂ to about 65 mol. % SiO₂, from about 0.1 mol. % to about 4 mol. % Al₂O₃, from about 15 mol. % B₂O₃ to about 20 mol. % B₂O₃, from about 5 mol. % Na₂O to about 13 mol. % Na₂O, from about 0.1 mol. % K₂O to about 4 mol. % K₂O, from about 5 mol. % CaO to about 13 mol. % CaO, The ratio of mol. % of Al₂O₃ and B₂O₃ to Na₂O, K₂O and CaO is from about 0.95 to about 1.05. The cladding glass composition can have a Young's modulus from about 79 GPa to about 83 GPa. The cladding glass composition can have a CTE from about 6.0 ppm/° C. to 8.0 ppm/° C.

In various embodiments, the cladding glass composition has a Young's modulus of at least 79 GPa, which may minimize flexing of the glass during processing and prevent damage to devices attached to the glass, such as when the glass is used as a carrier substrate for electronic devices. In some embodiments, the glass composition has a Young's modulus of greater than 79 GPa, greater than 85 GPa, greater than 90 GPa, greater than 95 GPa, or greater than 99 GPa. In some embodiments, the glass composition has a Young's modulus of less than 100 GPa, less than 95 GPa, less than 90 GPa, less than 85 GPa, or less than 80 GPa. In some particular embodiments, the glass composition has a Young's modulus from about 79 GPa to about 100 GPa, such as from about 80 GPa to about 100 GPa, from about 80 GPa to about 95 GPa, from about 80 GPa to about 90 GPa, from about 80 GPa to about 85 GPa, from 85 GPa to about 100 GPa, from about 85 GPa to about 95 GPa, from about 85 GPa to about 90 GPa, from 90 GPa to about 100 GPa, from about 90 GPa to about 95 GPa, from 95 GPa to about 100 GPa, or any range including and/or in-between any two of these values. However, it is contemplated that desired properties, including the Young's modulus, may vary depending on the particular embodiment, end use, and processing requirements for the glass composition.

In various embodiments, the cladding glass composition has a coefficient of thermal expansion between between 3.5 ppm/° C. and 5.5 ppm/° C. In some embodiments the CTE_{cladding} is from about 3.5 ppm/° C. to about 5.5 ppm/° C., such as from about 3.5 ppm/° C. to about 5.0 ppm/° C., from about 3.5 ppm/° C. to about 4.5 ppm/° C., from about 3.5 ppm/° C. to about 4.0 ppm/° C., from about 4.0 ppm/° C. to about 5.5 ppm/° C., from about 4.0 ppm/° C. to about 5.0 ppm/° C., from about 4.0 ppm/° C. to about 4.5 ppm/° C., from about 4.5 ppm/° C. to about 5.5 ppm/° C., from about 4.5 ppm/° C. to about 5.0 ppm/° C., from about 5.0 ppm/° C. to about 5.5 ppm/° C., or any range including and/or in-between any two of these values.

In some embodiments, the core glass compositions each have a liquidus viscosity suitable for forming the glass article using a fusion draw process as described herein. For example, each of the core glass compositions may have a liquidus viscosity of at least about 5 kP at least about 50 kP, at least about 100 kP, or at least about 200 kP. Additionally or alternatively, each of the core glass compositions comprises a liquidus viscosity of less than about 3000 kP, less than about 2000 kP, less than about 1000 kP, less than about 500 kP, less than about 200 kP, less than about 100 kP or less than about 75 kP. In some embodiments, the core glass layer may have a liquidus viscosity from about 5 kP to about 3000 kP, such as from about 5 kP to about 2000 kP, about 100 kP to about 1500 kP, about 200 kP to about 1000 kP, about 500 kP to about 800 kP, about 5 kP to about 100 kP, or about 5 kP to about 75 kP, or any range including and/or in-between any two of these values. In some embodiments, the core glass compositions may have a liquidus viscosity of from about 5 kP to about 75 kP.

A device can be formed comprising the glass article of the aforementioned compositions. Exemplary devices can include, but are not limited to, an electronic device, an automotive device, an architectural device, or an appliance device. The glass article can be formed into a glass laminates for use in microelectronic applications, such as for example, carrier materials. The glass article can be 3-D formed into complex shapes.

### Methods

A variety of methods may be used to produce the glass compositions and articles described herein. For example, the glass article 100 can be made using any suitable method. In general, glass article 100 and any of the layers 102, 104, 106 in the glass article 100 can be made using any of the methods disclosed in U.S. Pat. No. 9,340,451 entitled “Machining of Fusion-Drawn Glass Laminate Structures Containing a Photomachinable Layer,” issued May 17, 2016, and U.S. Patent Application Publication No. 2017/0073266 entitled “Glass Article and Method for Forming the Same,” published Mar. 16, 2017, each of which is hereby incorporated by reference in its entirety.

In another embodiment, the core glass compositions may be produced by methods which include melting a batch and forming a precursor glass comprising: from about 50 mol. % to about 70 mol. % SiO₂, from about 0.1 mol. % to about 10 mol. % Al₂O₃, from about 5 mol. % to about 25 mol. % B₂O₃, and from about 10 mol. % to about 30 mol. % of a modifier wherein the modifier is at least one of Na₂O, K₂O and CaO.

In another embodiment, a laminated glass article may be produced by methods which include contacting a molten core glass composition with a molten cladding glass composition to form a laminated glass article comprising a glass core layer disposed between a first glass cladding layer and a second glass cladding layer. The glass core layer can include a core glass composition having a Young's modulus (Y_{core}) of at least 79 GPa, and a coefficient of thermal expansion (CTE_{core}) between 8.0 ppm/° C. and 10.0 ppm/° C., and the first glass cladding layer and a second glass cladding layer comprise a cladding glass composition having a Young's modulus (Y_{clad}) of at least 79 GPa, and a coefficient of clad, thermal expansion (CTE_{clad}) between 3.5 ppm/° C. and 5.5 ppm/° C.

### EXAMPLES

Various embodiments will be further clarified by the following examples, which are in no way intended to limit this disclosure thereto.

### Example 1: Core Compositions

Table 1 provides examples of representative core glass compositions according to the present technology. Exemplary core glasses described herein exhibit a base composition comprising, in mole percent, of the constituents listed in Table 1. Various properties of the glasses are also set forth in Table 1. Glass 1 and Glass 2 are exemplary examples of the core glasses. The composition of a standard glass is shown in the comparative example. As shown, in Glass 1 which is a glass completely modified by sodium, the modulus exceeds 80 GPa and the CTE is 9.3 ppm/° C. In Glass 2, where Na is partially substituted with Ca, the modulus is retained above 80 GPa while reducing the CTE down to 8.0 ppm/° C. The glass compositions can thus be modified to tune the CTE value as desired without negatively impacting the high modulus. Further as can be seen from the table, both the CTE and Young's modulus for the comparative example are both lower than the CTE and Young's modulus for the core compositions.

| | Core Compositions | | Comparative |
|---|---|---|---|
| Composition in mol % | 1 | 2 | 3 |
| SiO₂ | 58.79 | 58.14 | 57.54 |
| Al₂O₃ | 2.00 | 2.01 | 2.00 |
| B₂O₃ | 18.66 | 18.70 | 19.15 |
| Na₂O | 20.55 | 14.10 | 14.43 |
| MgO | 0.00 | 0.00 | 6.88 |
| CaO | 0.00 | 7.04 | 0.00 |
| (Al₂O₃ + B₂O₃)/(Na₂O + CaO) | 1.01 | 0.98 | 1.47 |
| Density (g/cm³) | 2.513 | 2.511 | 2.44 |
| CTE (ppm/° C.) | 9.3 | 8.0 | 7.7 |
| Strain Pt. (° C.) | 525 | 530 | 507 |
| Anneal Pt. (° C.) | 554 | 560 | 539 |
| E (GPa) | 80.67 | 81.01 | 74.74 |
| poisson's ratio | 0.218 | 0.219 | 0.226 |

### Example 2: Cladding Compositions

Table 2 provides examples of representative cladding compositions according to the present technology. Exemplary cladding glasses described herein exhibit a base composition comprising, in mole percent, of the constituents listed in Table 2. Various properties of the glasses are also set forth in Table 2. These exemplary glass compositions possess the high modulus and low CTE needed for a cladding layer glass.

| | Clad Compositions | | | |
|---|---|---|---|---|
| Composition in mol % | 4 | 5 | 6 | 7 |
| SiO₂ | 46.65 | 46.34 | 54.11 | 58.59 |
| Al₂O₃ | 12.68 | 15.17 | 9.01 | 10.17 |
| B₂O₃ | 14.38 | 18.51 | 6.04 | 10.02 |
| Na₂O | 0.00 | 0.00 | 0.00 | 0.00 |
| MgO | 17.48 | 12.68 | 20.41 | 0.00 |
| CaO | 8.82 | 7.31 | 10.43 | 20.73 |
| Density (g/cm³) | 2.53 | 2.475 | 2.598 | 2.524 |
| CTE (ppm/° C.) | 4.7 | 4.1 | 5.1 | 4.8 |
| Strain Pt. (° C.) | 636 | 637 | 662 | 651.1 |
| Anneal Pt. (° C.) | 677 | 678 | 703 | 692.8 |
| E (GPa) | 87.49 | 81.5 | 92.87 | 81.29 |
| poisson's ratio | 0.268 | 0.266 | 0.26 | 0.244 |

### Example 3: Extended Compositions

Table 3 provides examples of representative compositions according to the present technology. The representative compositions have high modulus and intermediate CTE and can be core compositions or cladding compositions. Exemplary glasses described herein exhibit a base composition comprising, in mole percent, of the constituents listed in Table 3. Various properties of the glasses are also set forth in Table 3. The compositions also include use of K₂O which may be useful to tune the CTE properties. Compositions 8 and 9 follow the (Al₂O₃+B₂O₃)/(Na₂O+CaO) rule and demonstrate the effect of further Ca for Na substitution. Compositions 10, 11, and 12 follow a (Al₂O₃+B₂O₃)/(Na₂O+K₂O+CaO) rule, but open up the composition space to allow for the incorporation of K₂O in order to tune in the properties, such as CTE, to a greater extent.

| | Extended Compositions | | | | |
|---|---|---|---|---|---|
| Composition in mol % | 8 | 9 | 10 | 11 | 12 |
| SiO₂ | 58.86 | 59.94 | 61.80 | 61.37 | 59.91 |
| Al₂O₃ | 2.02 | 2.05 | 2.14 | 2.07 | 2.03 |
| B₂O₃ | 18.36 | 17.90 | 17.22 | 17.25 | 18.18 |
| Na₂O | 11.65 | 8.69 | 9.42 | 7.74 | 6.16 |
| K₂O | 0.01 | 0.01 | 2.17 | 2.35 | 2.63 |
| MgO | 0.00 | 0.00 | 0.00 | 0.00 | 0.00 |
| CaO | 9.11 | 11.41 | 7.25 | 9.21 | 11.08 |
| (Al₂O₃ + B₂O₃)/ | 0.98 | 0.99 | 1.03 | 1.00 | 1.02 |
| (Na₂O + K₂O + CaO) | | | | | |
| Density (g/cm³) | 2.506 | 2.489 | 2.484 | 2.481 | 2.488 |
| CTE (ppm/° C.) | 7.4 | 6.6 | 7.4 | 7.2 | 6.9 |
| Strain Pt. (° C.) | 540 | 551 | 534 | 537 | 548 |
| Anneal Pt. (° C.) | 571 | 583 | 567 | 571 | 580 |
| E (GPa) | 81.22 | 80.74 | 79.36 | 79.29 | 79.70 |
| poisson's ratio | 0.219 | 0.22 | 0.216 | 0.214 | 0.217 |

### Definitions

The term “coefficient of thermal expansion” or CTE is an average CTE over a particular range of temperatures. In various embodiments, the coefficient of thermal expansion of the glass composition is averaged over a temperature range from about 0° C. to about 300° C. In some embodiments, the coefficient of thermal expansion of the glass composition is averaged over a temperature range from about 20° C. to about 260° C.

In some embodiments, such as when the glass is flameworkable, the CTE may be measured over a temperature range of 0° C. to 300° C. via dilatometer. The glass is flameworked to a particular size with pointed tips. The sample is first immersed in a zero-degree ice bath, and then to a 300° C. bath, with the length of the sample being measured at each time. The CTE is then calculated based on the two measurements.

In other embodiments, such as when the glass is not flameworkable (e.g., glass laminates), the CTE may be measured over a temperature range of 20° C. to a maximum of 1000° C. via dilatometer. The glass is machined to a particular size with very flat ends and is placed in a small furnace which is heated up and cooled down with pre-determined rate (for example, 4° C./min up, a 5 minute temperature hold, and 4° C./min down), and the temperature and the length of sample is measured real time. A thermal expansion curve during both heating and cooling can be obtained. The average CTE number over a certain temperature range can be obtained from this measurement from both the heating and cooling curve.

The elastic modulus (also referred to as Young's modulus) of the substrate is provided in units of gigapascals (GPa). The elastic modulus of the substrate is determined by resonant ultrasound spectroscopy on bulk samples of the substrate.

The term “softening point,” as used herein, refers to the temperature at which the viscosity of the glass composition is 1×10^{7.6} poise.

The term “annealing point,” and “anneal point” as used herein, refers to the temperature at which the viscosity of the glass composition is 1×10¹³ poise.

The terms “strain point” and “Tₛₜᵣₐᵢₙ” as used herein, refers to the temperature at which the viscosity of the glass composition is 3×10¹⁴ poise.

As used herein, “transmission”, “transmittance”, “optical transmittance” and “total transmittance” are used interchangeably in the disclosure and refer to external transmission or transmittance, which takes absorption, scattering and reflection into consideration. Fresnel reflection is not subtracted out of the transmission and transmittance values reported herein. In addition, any total transmittance values referenced over a particular wavelength range are given as an average of the total transmittance values measured over the specified wavelength range. Further, as also used herein, “average absorbance” is given as:

$$\frac{2 - log ( average transmittance , \% )}{path length}$$

Concentration profiles of various constituent components in the glass, such as alkali constituent components, were measured by electron probe microanalysis (EPMA). EPMA may be utilized, for example, to discern compressive stress in the glass due to the ion exchange of alkali ions into the glass from compressive stress due to lamination.

The terms “glass” and “glass composition” encompass both glass materials and glass-ceramic materials, as both classes of materials are commonly understood. Likewise, the term “glass structure” encompasses structures comprising glass. The term “reconstituted wafer- and/or panel-level package” encompasses any size of reconstituted substrate package including wafer level packages and panel level packages.

The term “formed from” can mean one or more of comprises, consists essentially of, or consists of. For example, a component that is formed from a particular material can comprise the particular material, consist essentially of the particular material, or consist of the particular material.

As used herein, the term “ion exchanged”, “ion-exchanged”, or “ion-exchangeable” is understood to mean treating the glass with a heated solution containing ions having a different ionic radius than ions that are present in the glass surface and/or bulk, thus replacing those ions with, for example, smaller ions. For example, potassium can go in the glass to replace the sodium ions.

Directional terms as used herein—for example up, down, right, left, front, back, top, bottom, vertical, horizontal—are made only with reference to the figures as drawn and are not intended to imply absolute orientation unless otherwise expressly stated.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise. Also, the word “or” when used without a preceding “either” (or other similar language indicating that “or” is unequivocally meant to be exclusive—e.g., only one of x or y, etc.) shall be interpreted to be inclusive (e.g., “x or y” means one or both x or y).

The term “and/or” shall also be interpreted to be inclusive (e.g., “x and/or y” means one or both x or y). In situations where “and/or” or “or” are used as a conjunction for a group of three or more items, the group should be interpreted to include one item alone, all the items together, or any combination or number of the items. Moreover, terms used in the specification and claims such as have, having, include, and including should be construed to be synonymous with the terms comprise and comprising. Other elements may optionally be present other than the elements specifically identified by the “and/or” clause, whether related or unrelated to those elements specifically identified. As a non-limiting example, a reference to “X and/or Y” can refer, in one embodiment, to X only (optionally including elements other than Y); in another embodiment, to Y only (optionally including elements other than X); in yet another embodiment, to both X and Y (optionally including other elements).

All disclosed ranges are to be understood to encompass and provide support for claims that recite any and all subranges or any and all individual values subsumed by each range. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth). Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member. Thus, for example, a group having 1-3 layers refers to groups having 1, 2, or 3 layers. Similarly, a group having 1-5 layers refers to groups having 1, 2, 3, 4, or 5 layers, and so forth.

The drawings shall be interpreted as illustrating one or more embodiments that are drawn to scale and/or one or more embodiments that are not drawn to scale. This means the drawings can be interpreted, for example, as showing: (a) everything drawn to scale, (b) nothing drawn to scale, or (c) one or more features drawn to scale and one or more features not drawn to scale. Accordingly, the drawings can serve to provide support to recite the sizes, proportions, and/or other dimensions of any of the illustrated features either alone or relative to each other. Furthermore, all such sizes, proportions, and/or other dimensions are to be understood as being variable from 0-100% in either direction and thus provide support for claims that recite such values or any and all ranges or subranges that can be formed by such values.

The terms recited in the claims should be given their ordinary and customary meaning as determined by reference to relevant entries in widely used general dictionaries and/or relevant technical dictionaries, commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used in a manner that is more expansive than its ordinary and customary meaning, the term should be given its ordinary and customary meaning plus the additional expansive meaning, or (b) if a term has been explicitly defined to have a different meaning by reciting the term followed by the phrase “as used in this document shall mean” or similar language (e.g., “this term means,” “this term is defined as,” “for the purposes of this disclosure this term shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained in this document should be considered a disclaimer or disavowal of claim scope.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the present application and relevant art and should not be interpreted in an idealized or overly formal sense unless expressly so defined herein. While not explicitly defined below, such terms should be interpreted according to their common meaning.

In addition, where features or aspects of the disclosure are described in terms of Markush groups, those skilled in the art will recognize that the disclosure is also thereby described in terms of any individual member or subgroup of members of the Markush group.

Unless the context indicates otherwise, it is specifically intended that the various features of the invention described herein can be used in any combination. Moreover, the disclosure also contemplates that in some embodiments, any feature or combination of features set forth herein can be excluded or omitted. To illustrate, if the specification states that a complex comprises components A, B and C, it is specifically intended that any of A, B or C, or a combination thereof, can be omitted and disclaimed singularly or in any combination.

Unless explicitly indicated otherwise, all specified embodiments, features, and terms intend to include both the recited embodiment, feature, or term and biological equivalents thereof.

All patents, patent applications, provisional applications, and publications referred to or cited herein are incorporated by reference in their entirety, including all figures and tables, to the extent they are not inconsistent with the explicit teachings of this specification.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

When a composition herein is given a range of 0-Z wt. %, this range refers to the amount of material added to a batch and excludes contaminant levels of the same material. As those skilled in the art would appreciate, metals, for example, sodium and iron, are frequently found at contaminant levels in batched glass and glass products. Consequently, it is to be understood that in those cases where a material is not specifically added to a batch, added, any such material that may be present in an analyzed sample of the final glass material is contaminant material. Except for iron oxides, where contaminant levels are typically around the 0.03 wt. % (300 ppm) level, contaminant levels are less than 0.005 wt. % (50 ppm). The term “consistently essentially of” is to be understood as not including contaminant levels of any material.

1. A glass composition comprising:
from about 50 mol. % to about 70 mol. % SiO₂;
from about 0.1 mol. % to about 10 mol. % Al₂O₃;
from about 5 mol. % to about 25 mol. % B₂O₃; and
from about 10 mol. % to about 30 mol. % of a modifier, wherein the modifier is at least one of Na₂O, K₂O and CaO.

2. The glass composition of claim 1, wherein the ratio of mol. % of Al₂O₃ and B₂O₃ to modifier is from about 0.95 to about 1.05.

3. The glass composition of claim 1 having a Young's modulus of at least 79 GPa.

4. The glass composition of claim 3, wherein the Young's modulus of the glass composition is less than 100 GPa.

5. The glass composition of claim 1 having a coefficient of thermal expansion from 8.0 ppm/° C. to 10.0 ppm/° C.

6. The glass composition of claim 1, wherein the modifier comprises Na₂O and CaO.

7. The glass composition of claim 1, wherein the modifier comprises Na₂O, K₂O and CaO.

8. The glass composition of claim 1, wherein the modifier converts boron in B₂O₃ from trigonal to tetrahedral configuration.

9. The glass composition of claim 1, further comprises from about 0 mol. % to about 3 mol. % of one or more of Y₂O₃, La₂O₃, ZrO₂, TiO₂, BeO or Ta₂O₅.

10. A glass article comprising a glass core layer disposed between a first glass cladding layer and a second glass cladding layer, wherein the glass core layer comprises the glass composition of claim 1.

11. A glass article comprising:
a glass core layer disposed between a first glass cladding layer and a second glass cladding layer, wherein:
the glass core layer comprises a glass composition having a Young's modulus (Y_{core}) of at least 79 GPa, and a coefficient of thermal expansion (CTE_{core}) between 8.0 ppm/° C. and 10.0 ppm/° C., and
the first glass cladding layer and a second glass cladding layer comprise a glass composition having a Young's modulus (Y_{clad}) of at least 79 GPa, and a coefficient of thermal expansion (CTE_{clad}) between 3.5 ppm/° C. and 5.5 ppm/° C.

12. The glass article of claim 11, wherein the glass article has a coefficient of thermal expansion (CTE_{article}) between 3.5 ppm/° C. to 10.0 ppm/° C.

13. The glass article of claim 11, wherein the glass article has a coefficient of thermal expansion (CTE_{article}) between 4 ppm/° C. and 9.5 ppm/° C.

14. The glass article of claim 11, wherein the glass article has a Young's Modulus (Y_{articie}) between 80 Gpa and 100 Gpa.

15. The glass article of claim 11, wherein the glass composition of the glass core layer comprises:
from about 50 mol. % to about 70 mol. % SiO₂;
from about 0.1 mol. % to about 10 mol. % Al₂O₃;
from about 5 mol. % to about 25 mol. % B₂O₃; and
from about 10 mol. % to about 30 mol. % of a modifier, wherein the modifier is at least one of Na₂O, K₂O and CaO.

16. The glass article of claim 11, wherein the glass composition of the first glass cladding layer and the second glass cladding layer comprises:
from about 40 mol. % to about 65 mol. % SiO₂;
from about 0.1 mol. % to about 20 mol. % Al₂O₃;
from about 5 mol. % to about 25 mol. % B₂O₃; and
from about 5 mol. % to about 40 mol. % of a modifier, wherein the modifier is at least one of MgO and CaO.

17. The glass article of claim 11, wherein the glass core layer has an average core coefficient of thermal expansion (CTE_{coreAvg}) and the first glass cladding layer and the second glass cladding layer have an average cladding coefficient of thermal expansion (CTE_{cladAvg}) that is less than the average core coefficient of thermal expansion (CTE_{coreAvg}).

18. A method for forming a glass composition, the method comprising:
melting a batch and forming a precursor glass comprising:
from about 50 mol. % to about 70 mol. % SiO₂;
from about 0.1 mol. % to about 10 mol. % Al₂O₃;
from about 5 mol. % to about 25 mol. % B₂O₃; and
from about 10 mol. % to about 30 mol. % of a modifier wherein the modifier is at least one of Na₂O, K₂O and CaO.

19. A method for forming a laminated glass article, the method comprising:
contacting a molten core glass composition with a molten cladding glass composition to form a laminated glass article comprising a glass core layer disposed between a first glass cladding layer and a second glass cladding layer, wherein:
the glass core layer comprises a glass composition having a Young's modulus (Y_{core}) of at least 79 GPa, and a coefficient of thermal expansion (CTE_{core}) between 8.0 ppm/° C. and 10.0 ppm/° C., and
the first glass cladding layer and a second glass cladding layer comprise a glass composition having a Young's modulus (Y_{clad}) of at least 79 GPa, and a coefficient of thermal expansion (CTE_{clad}) between 3.5 ppm/° C. and 5.5 ppm/° C.

20. A device comprising the glass composition of claim 1, wherein the device is an electronic device, an automotive device, an architectural device, or an appliance device.

21. (canceled)

22. A device comprising the glass article of claim 11, wherein the device is an electronic device, an automotive device, an architectural device or an appliance device.

23. (canceled)
